(19) United States
(12) Patent Application Publication
(10) Pub. No.: US 2025/0200532 A1
(43) Pub. Date: Jun. 19, 2025

(54) SYSTEM AND METHOD FOR IDENTIFYING A TIMEPIECE

(71) Applicant: Ritual Science, LLC, Sunnyvale, CA (US)

(72) Inventors: Allen Ming-kuang Han, Mountain View, CA (US); Luis Enrique Ramirez Sulbaran, New Taipei City (TW)

(21) Appl. No.: 18/974,165

(22) Filed: Dec. 9, 2024

Related U.S. Application Data
(60) Provisional application No. 63/610,588, filed on Dec. 15, 2023.

(51) Int. Cl. G06Q 10/20; G01M 7/02; G01M 7/08; G04C 15/00

(52) U.S. Cl. CPC G06Q 10/20; G01M 7/02; G01M 7/08; G04C 15/0054

(57) ABSTRACT

A method for uniquely identifying a timepiece includes, during a timepiece identification period: accessing a library of heartbeat profiles, associated with a population of verified timepieces, defined prior to the timepiece identification period; at a timepiece maintenance station, triggering a probe to contact an unverified timepiece arranged within the timepiece maintenance station; at a vibration sensor coupled to the probe, capturing a vibration signal representing vibrations generated by a movement of the unverified timepiece; extracting a timeseries of periodic characteristics from the vibration signal; and, in response to the timeseries of periodic characteristics approximating periodic characteristics represented in a power reserve range within a heartbeat profile, in the library of heartbeat profiles, identifying the unverified timepiece as a verified timepiece specified for the heartbeat profile.

### CROSS-REFERENCE TO RELATED APPLICATIONS

This Application claims the benefit of U.S. Provisional Application No. 63/610,588, filed on 15 Dec. 2023, which is hereby incorporated in its entirety by this reference.

### TECHNICAL FIELD

This invention relates generally to the field of timepieces and, more specifically, to a new and useful system and method for identifying a timepiece in the field of timepieces.

### BRIEF DESCRIPTION OF THE FIGURES

FIG. 1 is a flowchart representation of a method;

FIG. 2 is a flowchart representation of the method;

FIG. 3 is a flowchart representation of the method;

FIG. 4 is a flowchart representation of the method;

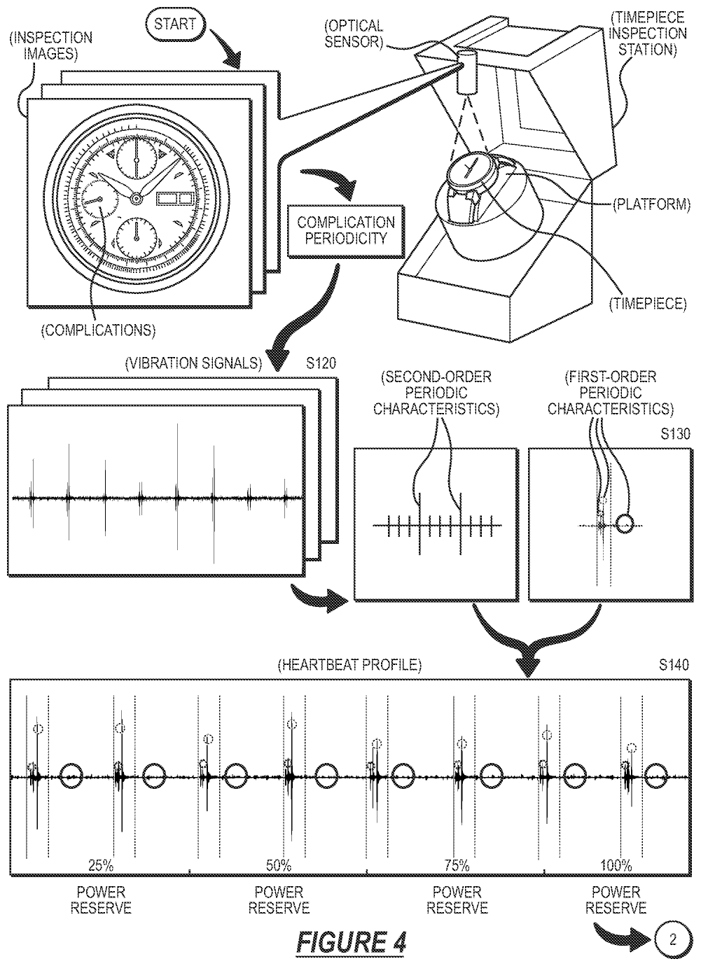

FIGS. 5A and 5B are a schematic representation of a system; and

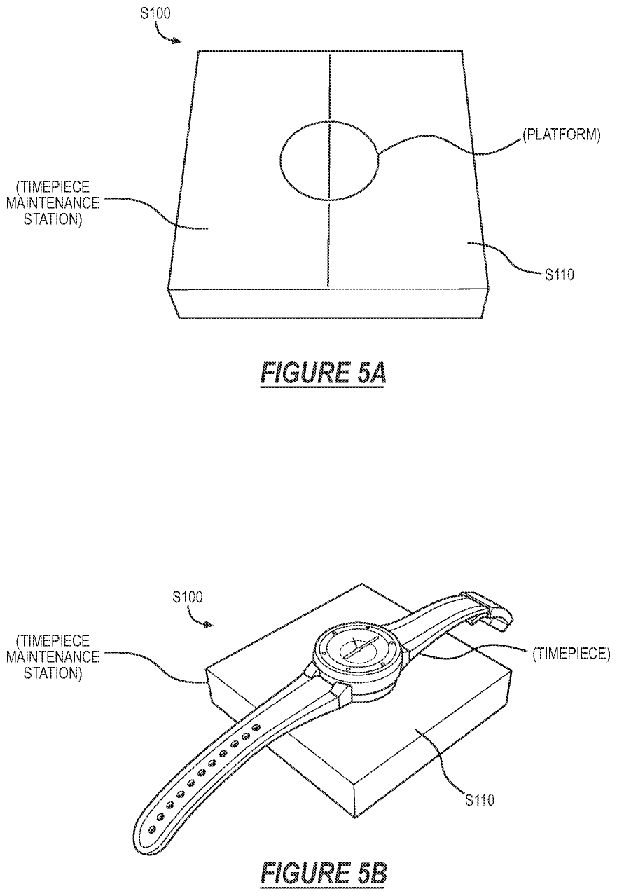

FIGS. 6A and 6B are schematic representations of a variation of the system.

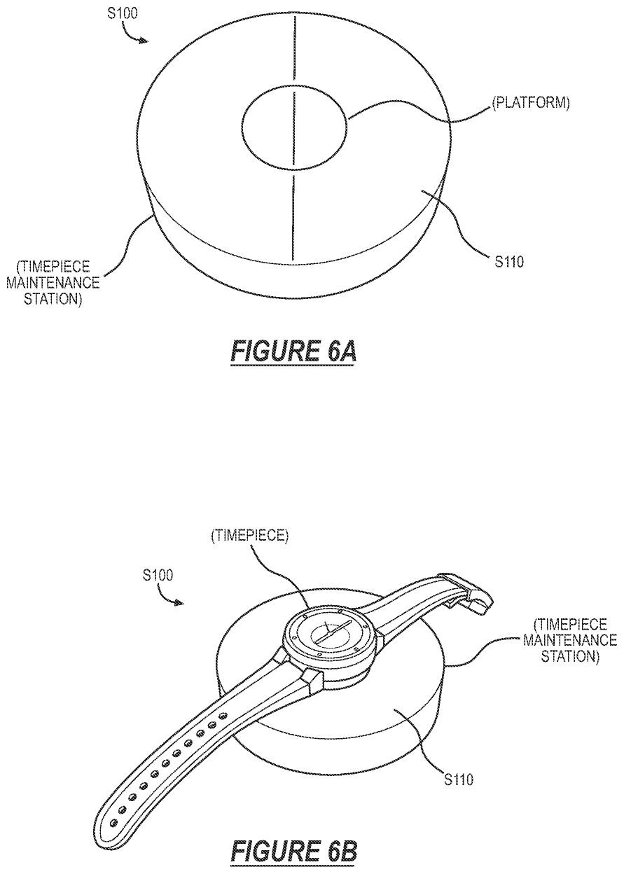

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method: Timepiece Identification

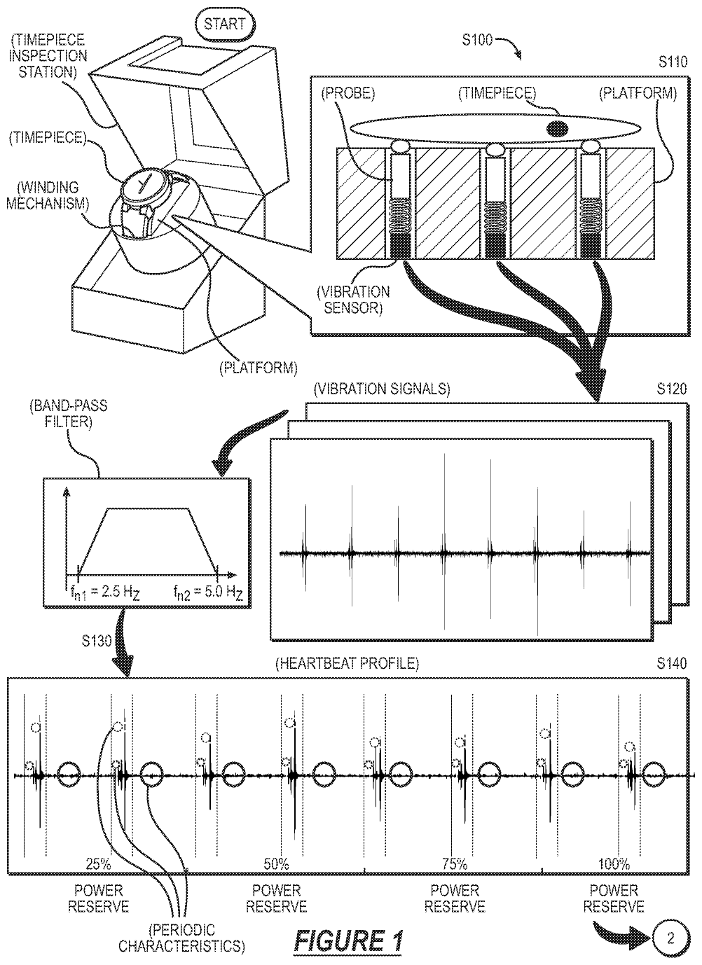

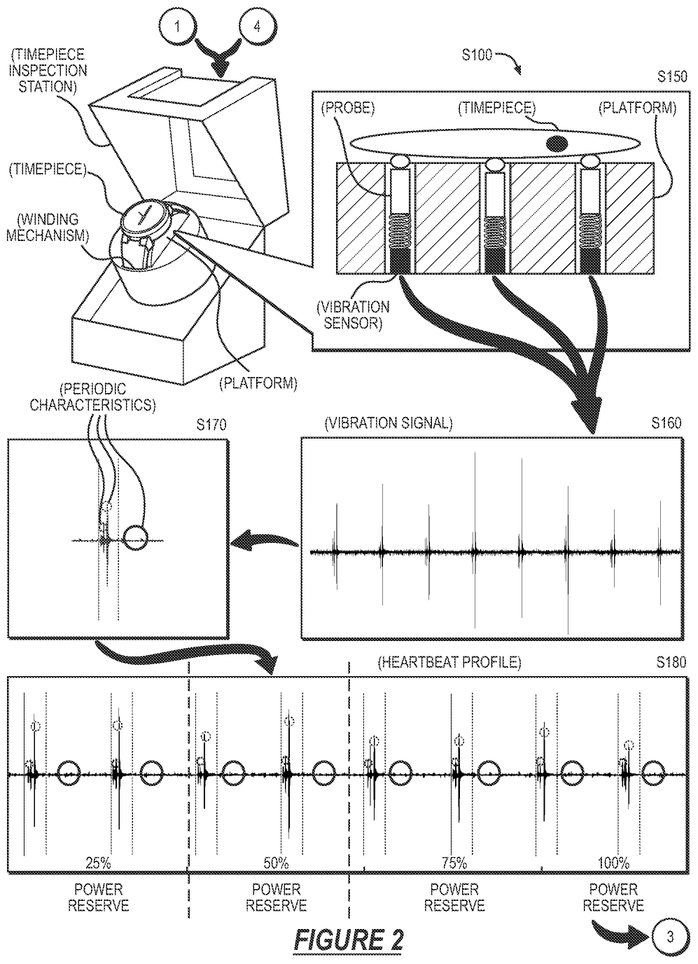

As shown in FIGS. 1 and 2, a method S100 for identifying a timepiece includes, during a first timepiece registration period: at a timepiece maintenance station (or “timepiece identification station”), triggering a first probe to contact a first unverified timepiece arranged within the timepiece maintenance station in Block S110; and at a first vibration sensor coupled to the first probe, capturing a first set of vibration signals characterizing power reserve depletion in a first movement of the first unverified timepiece in Block S120.

The method S100 further includes, during the first timepiece registration period: extracting a first timeseries of periodic characteristics from the first set of vibration signals in Block S130; and defining a first heartbeat profile for uniquely identifying the first unverified timepiece as a first verified timepiece, the first heartbeat profile representing the first timeseries of periodic characteristics as a function of power reserve in the first movement in Block S140.

The method S100 also includes, during a first timepiece identification period following the first timepiece registration period: at the timepiece maintenance station, triggering the first probe to contact a second unverified timepiece arranged within the timepiece maintenance station in Block S150; and, at the first vibration sensor coupled to the first probe, capturing a second vibration signal representing vibrations generated by a second movement of the second unverified timepiece in Block S160.

The method S100 further includes, during the first timepiece identification period following the first timepiece registration period: extracting a second timeseries of periodic characteristics from the second vibration signal in Block S170; and, in response to the second timeseries of periodic characteristics approximating periodic characteristics represented in a first power reserve range within the first heartbeat profile, identifying the second unverified timepiece as the first verified timepiece in Block S180.

### 1.1 Maintaining Power Reserve

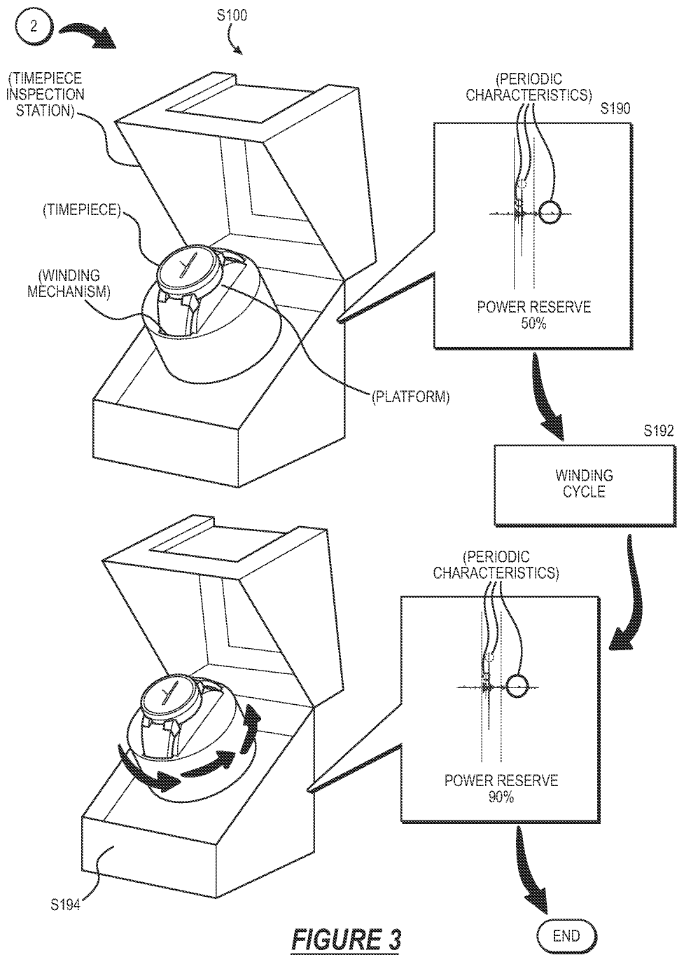

In one variation, shown in FIG. 3, the method S100 also includes: estimating a first power reserve level of the first verified timepiece based on the first power reserve range within the first heartbeat profile in Block S190; defining a winding cycle executable by the timepiece maintenance station to maintain the first verified timepiece at a target power reserve level in Block S192; and, at the timepiece maintenance station, initiating the winding cycle to increase the first power reserve level of the first verified timepiece toward the target power reserve level in Block S194.

### 2. Applications

Generally, Blocks of the method S100 can be executed by a system including a timepiece maintenance station in cooperation with a computer system: to receive a timepiece at the timepiece maintenance station; to record vibrations (e.g., peak-to-peak intensities, signal slope) from the timepiece (e.g., escapement, balance wheel, mainspring)—as a function of time as the mainspring in the timepiece unwinds and as the power reserve of the timepiece diminishes; and to generate a heartbeat profile (uniquely) representing the timepiece based on the recorded vibrations (e.g., peak-to-peak intensities, mainspring) detected in the timepiece by the timepiece maintenance station. More specifically, the system can: record a timeseries of vibration signals (e.g., two-dimensional plot, three-dimensional plot) from a vibration sensor—in contact with the timepiece loaded into the timepiece maintenance station—as the timepiece transitions from a maximum (e.g., 100%) power reserve to a minimum (e.g., 5%) power reserve; and correlate a set of time windows across the heartbeat profile to a power reserve (e.g., 20%, 50%, 80%) of the movement of the timepiece.

Additionally, the system can implement Fourier transform techniques, time domain features (e.g., energy, amplitude, autocorrelation), and spectral domain features (e.g., power spectrum, mel-frequency cepstral coefficient, chromatic features) to derive periodic characteristics (e.g., frequencies and amplitudes)—of the timeseries of vibration signals—that correspond to vibrations generated within the timepiece by particular components (e.g., escapement, balance wheel, mainspring, discrete complications) of the movement. The system can then store the timeseries of vibration signals and these periodic characteristics as a heartbeat profile (e.g., a plot of peak-to-peak intensities as a function of time) uniquely representing the timepiece.

The system can then: associate the heartbeat profile with a particular make, model, and/or serial number of a timepiece at the timepiece maintenance station; and store the heartbeat profile associated with the make, model, and/or serial number of the timepiece in a user profile associated with a user interfacing with the timepiece maintenance station. For example, the system can: generate a prompt requesting a user to input a set of identifiers (e.g., make, model, serial number) for the timepiece at the timepiece maintenance station; serve the prompt to the user, such as at a mobile device (e.g., tablet) associated with the user and/or at an interactive display coupled to the timepiece maintenance station; and receive the set of identifiers from the user at the mobile device and/or at the interactive display. The system can then: associate the set of identifiers received from the user with the heartbeat profile of the timepiece; and store the heartbeat profile associated with the set of identifiers in the user profile at the computer system.

In another example, the system can: access an image captured from an optical sensor at the timepiece maintenance station, defining a field of view of a surface of interest on the timepiece (e.g., dial); implement computer vision techniques (e.g., recognition) to derive a make and model of the timepiece depicted in the image; associate the make and model with the heartbeat profile of the timepiece; and store the heartbeat profile, make, and model of the timepiece in the user profile at the computer system. Therefore, the system can repeat this process to generate a user profile representing a suite of timepieces associated with the user interfacing with the timepiece maintenance station.

### 2.1 Timepiece Re-identification

Subsequently, when the timepiece is removed and then returned to the timepiece maintenance station, the system can: as described above, during a data capture cycle, record a timeseries (e.g., 30 seconds) of vibration signals for the timepiece at the timepiece maintenance station; derive a timeseries of periodic characteristics (e.g., frequencies, amplitudes) in the timeseries of vibration signals; and identify a time window (e.g., 10 seconds) of a stored heartbeat profile approximating the timeseries of periodic characteristics of the timeseries of vibration signals. Accordingly, the system can then, implement machine learning, deep learning, and/or artificial intelligence techniques to: identify the timepiece at the timepiece maintenance station as corresponding to the stored heartbeat profile; estimate a power reserve (e.g., 70%) of the timepiece based on the time window in the heartbeat profile approximating the timeseries of periodic characteristics; and define a winding cycle (e.g., ten turns every 5 hours) to maintain the timepiece at a target power reserve at the timepiece maintenance station.

Therefore, based on the heartbeat profile and a timeseries of vibration signals (e.g., peak-to-peak intensities) of the timepiece, the system can: interpret a power reserve of the movement in the timepiece; and maintain a target power reserve (e.g., 90%) of the movement, by triggering the winding cycle at the timepiece maintenance station, to preserve an operating state of the movement in the timepiece.

### 2.2 New Timepiece

Alternatively, the system can: based on the timeseries of periodic characteristics, identify absence of a stored heartbeat profile as corresponding to a stored heartbeat profile for a timepiece; and, in response to identifying the absence, detect a new timepiece—not present in the user profile—at the timepiece maintenance station.

Subsequently, the system can then: trigger a winding cycle (e.g., 30 turns) to induce a maximum power reserve at the timepiece; and, as described above, initiate an initial data capture cycle to record a timeseries of vibration signals corresponding to a transition from the maximum power reserve (e.g., 95%) to a minimum power reserve (e.g., 5%) for the timepiece. Accordingly, the system can then: derive a new heartbeat profile representing the timeseries of vibration signals as a function of power reserve uniquely representing the new timepiece at the timepiece maintenance station; associate the new heartbeat profile with the identification data received from the user; query the user profile for a stored heartbeat profile corresponding to the new heartbeat profile; and, in response to detecting absence of a stored heartbeat profile corresponding to the new heartbeat profile, generate a prompt requesting a user to confirm identification of the new timepiece at the timepiece maintenance station.

The system can then: serve the prompt to the user, such as at a mobile device associated with the user; receive identification data (e.g., make, model, serial number) from the user corresponding to the new timepiece; associate heartbeat profile with the identification data received from the user; and store the heartbeat profile in the user profile associated with the user. Therefore, the system can maintain a user profile containing heartbeat profiles uniquely representing a suite of timepieces currently and/or previously owned by the user.

### 2.3 Timepiece Maintenance Station

The timepiece maintenance station can include: a receptacle; a platform (e.g., pillow, jig) arranged within the receptacle configured to receive a timepiece (e.g., case of a timepiece); a vibration sensor (e.g., piezo, accelerometer, microphone, linear variable differential transformer, laser doppler vibrometer) coupled to a probe (e.g., plastic probe) configured to contact the case of the timepiece on the platform; and a controller configured to record vibration signals from the vibration sensor. Additionally, the timepiece maintenance station includes a winding mechanism arranged within the receptacle and configured to rotate (e.g., clockwise, counter-clockwise) the platform—and therefore increase power reserve at the mainspring of the movement—within the receptacle. Accordingly, the system can: receive a case of a timepiece on the platform at the timepiece maintenance station; trigger the probe—coupled to the vibration sensor—to contact a target location (e.g., facet, periphery) of the case of the timepiece arranged on the platform; and initiate a data capture cycle to record a timeseries of vibration signals (e.g., peak-to-peak intensities) during a target time period (e.g., one hour, five hours) at the timepiece maintenance station.

In one example, the system can: initiate a winding cycle to induce a high power reserve (e.g., 95%) at the movement by triggering the winding mechanism to rotate the platform—and therefore the movement—within the receptacle; and, following the winding cycle, execute an initial data capture cycle to capture a timeseries of vibration signals (e.g., peak-to-peak intensities) during transition from high power reserve to low power reserve of the movement. The system can then: implement Fourier transform techniques to identify a timeseries of periodic characteristics (e.g., frequencies, amplitudes) across the timeseries of vibration signals corresponding to components (e.g., escapement, balance wheel, mainspring) of the movement; and store the timeseries of vibration signals and the timeseries of periodic characteristics as the heartbeat profile representing vibration signals as a function of power reserve for the movement of the timepiece. Therefore, the system can: capture a timeseries of vibration signals of a timepiece at the timepiece maintenance station; extract a timeseries of periodic characteristics from the timeseries of vibration signals for the timepiece; identify a time window in the heartbeat profile approximating the timeseries of periodic characteristics; and interpret a power reserve of the movement based on the time window in the heartbeat profile. Additionally, the system can, in response to the power reserve falling below the target power reserve, initiate a winding cycle to increase the power reserve of the movement toward the target power reserve by triggering the winding mechanism to rotate (e.g., clockwise, counterclockwise) the platform supporting the movement, thereby maintaining an operating condition for the movement at the timepiece maintenance station.

Additionally or alternatively, the timepiece maintenance station can include a suite of sensors such as a set (e.g., more than one) of vibration sensors in contact with the case (e,g., bezel, crystal) of the timepiece, one or more light-based vibration sensors aimed toward the timepiece, one or more optical sensors defining the field of view configured to capture a surface of interest (e.g., dial) of the timepiece.

### 3. Terms and Definitions

Generally, “movement” as referenced herein is the internal mechanism of a mechanical timepiece that automatically winds to move hands (e.g., second hand, minute hand, hour hand) and that powers the complications (e.g., chronograph, annual calendar) of the timepiece.

Generally, “power reserve” as referenced herein is a remaining duration of operating time proportional a maximum duration of operating time corresponding to winding of a mainspring of the movement.

Generally, “heartbeat profile” as referred to herein is a timeseries of vibrations (e.g., peak-to-peak intensities) from a timepiece represented as a function of power reserve (e.g., from 0% to 100% power reserve) for a movement in the timepiece.

Generally, “periodic characteristics” as referred to herein are waveform properties (e.g., peak amplitudes, frequencies, signal slope) in a timeseries of vibrations.

### 4. System

Blocks of the method S100 recite, during a first timepiece registration period at a timepiece maintenance station, triggering a first probe to contact a first unverified timepiece arranged within the timepiece maintenance station in Block S110.

Generally, the system includes a timepiece maintenance station cooperating with a computer system (e.g., remote computer system) to capture vibration signals (e.g., peak-to-peak intensities) from a timepiece arranged at the timepiece maintenance station. In particular, the timepiece maintenance station: is configured to receive a timepiece, such as from a user interfacing with the timepiece maintenance station; includes a vibration sensor configured to contact (e.g., via a probe) a case—containing the movement—of the timepiece and detect vibrations (e.g., peak-to-peak intensities) from the timepiece; and can execute a data capture cycle to record a timeseries (e.g., three hours, twenty-four hours) of vibration signals from the timepiece arranged at the timepiece maintenance station. Thus, the computer system—in communication with the timepiece maintenance station—can: receive the timeseries of vibration signals from the timepiece maintenance station; and store the timeseries of vibration signals representing the timepiece within a database (e.g., local database, remote database) at the computer system.

### 4.1 Timepiece Maintenance Station

In one implementation, the timepiece maintenance station includes: a receptacle; a platform (e.g., pillow, jig) arranged within the receptacle configured to receive a timepiece; a vibration sensor (e.g., piezo, accelerometer, microphone, linear variable differential transformer) coupled to a probe (e.g., plastic probe) configured to contact a case—containing the movement—of the timepiece on the platform; and a controller configured to record vibration signals from the vibration sensor. In particular, the platform: can define features that function to locate the timepiece in a particular orientation to receive the probe coupled to the vibration sensor within the receptacle; and is coupled to a winding mechanism arranged within the receptacle and configured to rotate (e.g., clockwise, counter-clockwise) the platform—and therefore the movement of the timepiece—within the receptacle.

Additionally, the vibration sensor: is coupled to a probe arranged within the receptacle and configured to contact a target location (e.g., front face, rear face, periphery) of the case of the timepiece arranged on the platform; and can detect vibration signals (e.g., peak-to-peak intensities) at the movement of the timepiece, such as oscillations of the balance wheel, the mainspring, and/or the escapement of the movement. Thus, the timepiece maintenance station can: trigger rotation (e.g., clockwise, counter-clockwise) of the platform to induce winding of the mainspring of the movement in order to increase power reserve at the movement; trigger the probe—coupled to the vibration sensor—to contact a target location of the case of the timepiece arranged on the platform; during a target time period (e.g., thirty seconds, two minutes, three hours), record a timeseries of vibration signals from the vibration sensor; and transmit the timeseries of vibration signals to the computer system, such as to a remote computer system in wireless communication with the controller.

In this implementation, the timepiece maintenance station can: receive the timepiece at the platform, such as from a user interfacing with the timepiece maintenance station, in order to align a facet of the timepiece (e.g., front facet, rear facet) orthogonal a tip (e.g., plastic tip, rubber tip) of the probe; and trigger the probe (e.g., via an actuator) to contact the tip (e.g., plastic tip, rubber tip)—arranged at a distal end of the probe—with the facet (e.g., front facet, rear facet) of the timepiece. For example, the platform can: orient a rear facet of the timepiece orthogonal the tip of the probe within the receptacle; and orient the front facet, opposite the rear facet, of the timepiece relative a window arranged at the receptacle in order to prevent contact of the tip of the probe with the front crystal—and therefore scratches on the front crystal—at the front facet and enable the user to observe the front facet of the timepiece within the receptacle. Accordingly, the controller can then initiate a data capture cycle, as described below, to: during a target time period, record a timeseries of vibration signals (e.g., peak-to-peak intensities) from the timepiece arranged on the platform; and transmit the timeseries of vibration signals to a computer system.

In another implementation, the timepiece maintenance station includes a robotic arm: coupled to the probe; and configured to maneuver the probe about the timepiece arranged on the platform in order to contact a target location (e.g., facet, periphery) of the case of the timepiece. For example, the controller can: maneuver the robotic arm to orient the tip of the probe orthogonal a rear facet of the case of the timepiece, orthogonal a front facet of the case of the timepiece, and/or about the bezel of the case of the timepiece; and initiate a data capture cycle to record vibration signals (e.g., peak-to-peak intensities) from the timepiece.

In another implementation, the timepiece maintenance station further includes a dampening mechanism (e.g., gyroscope, centrifugal dampening system): coupling the platform to the receptacle; and configured to isolate vibrations at the timepiece arranged on the platform within the receptacle from external disturbances applied to the receptacle (e.g., transportation of the receptacle). Additionally or alternatively, the timepiece maintenance station can include a secondary vibration sensor (e.g., accelerometer) coupled to the receptacle and configured to detect vibration signals (or “background noise”) from the receptacle during the data capture cycle. Accordingly, the system can then implement Fourier transform techniques to isolate the vibration signals captured from the timepiece based on the vibration signals captured from the secondary vibration sensor.

Therefore, the system can, at the timepiece maintenance station: trigger a winding cycle to rotate the platform—and therefore the movement of the timepiece—in order to increase a power reserve of the movement; and trigger a data capture cycle to record isolated vibrations (e.g., peak-to-peak intensities) from a target location on the case of the timepiece during a target time period.

### 4.2 Multiple Probes

In one implementation, the timepiece maintenance station can include a set of probes: coupled to a set of vibration sensors; and configured to contact a set of target locations across the timepiece arranged on the platform within the receptacle. For example, the set of probes can include: a first probe coupled to a first vibration sensor and configured to contact a periphery (e.g., bezel) of the case of the timepiece along a first axis relative a center of the front facet (e.g., front crystal) of the case of the timepiece; a second probe coupled to a second vibration sensor and configured to contact a periphery (e.g., bezel) of the case of the timepiece along a second axis, orthogonal the first axis, relative the center of the front facet of the timepiece; and a third probe coupled to a third vibration sensor and configured to contact a rear facet (e.g., back crystal) of the case of the timepiece arranged on the platform. During the data capture cycle, the controller can: record a first timeseries of vibration signals from the first vibration sensor; record a second timeseries of vibration signals from the second vibration sensor; and record a third timeseries of vibration signals from the third vibration sensor.

Therefore, the system can, based on the first timeseries of vibration signals, the second timeseries of vibration signals, and the third timeseries of vibration signals, implement triangulation techniques to generate a model (e.g., three-dimensional model) representing the timepiece and depicting detected vibration signals across the model representing the timepiece.

### 4.3 Optical Sensor

In another implementation, the timepiece maintenance station further includes an optical sensor (e.g., camera, x-ray sensor, infrared sensor) arranged within the receptacle and defining a field of view across the front facet of the timepiece arranged on the platform. During the data capture cycle, the system can: record a timeseries of vibration signals from the vibration sensor coupled to the timepiece; and, concurrently, access a timeseries of images from the optical sensor depicting complications (e.g., second hand, minute hand, hour hand, month, date) on the front facet of the timepiece. The system can then: implement computer vision techniques (e.g., object detection, edge detection) to track locations of complications of the timepiece during the data capture cycle; and correlate changes in locations of the complications to amplitudes and/or frequencies in the timeseries of vibration signals from the vibration sensor.

For example, based on the timeseries of images, the system can: detect a timeseries of locations of a minute hand complication of the timepiece during the data capture cycle; correlate the timeseries of locations of the minute hand complication to a first frequency across the timeseries of vibration signals; detect a timeseries of locations of an hour hand complication of the timepiece during the data capture cycle; and correlate the timeseries of locations of the hour hand complication to a second frequency across the timeseries of vibration signals. Therefore, the system can: track periodic locations of complications of the timepiece during the data capture cycle; and correlate the periodic locations of the complications to frequencies and/or amplitudes across the vibration signals recorded from the vibration sensor coupled to the timepiece.

Additionally or alternatively, the system can: extract a set of visual features from a set of images depicting the timepiece (e.g., front facet, rear facet of the timepiece); and, based on the set of visual features, detect transmittance of sapphire and/or glass in the timepiece; detect the refractive quality of the sapphire and/or glass in the timepiece; detect impurity content of sapphire and/or glass in the timepiece; and interpret impurity contentment of the sapphire and/or glass in the timepiece.

### 4.4 Timepiece Platform+Embedded Probes

In one implementation, shown in FIG. 1, the timepiece maintenance station includes a platform configured to consistently and repeatably locate test locations on the rear facet of the timepiece in alignment with a set of probes embedded within the platform. In this implementation, the timepiece maintenance station includes a set of probes (e.g., four probes) vertically embedded within the platform and configured to contact the rear facet of the timepiece. Accordingly, the timepiece maintenance station can concurrently sample vibration signals across a set of test locations on the rear facet of the timepiece.

For example, the timepiece maintenance station can include: a platform (e.g., a demilune platform) configured to receive a rear facet of a timepiece; a primary probe centrally embedded within the platform and configured to contact a primary test location on the rear facet of the timepiece; and a secondary embedded within the platform offset from the primary probe and configured to contact a secondary test location, offset from the primary test location, on the rear facet of the timepiece. In one example, the primary probe is coupled to a primary vibration sensor configured to record vibration signals generated by the movement of the timepiece at the primary test location. Additionally, the secondary probe is coupled to a secondary vibration sensor configured to record vibration signals generated by the movement of the timepiece at the secondary test location. Furthermore, the timepiece maintenance station can also include: a primary actuator (e.g., a linear actuator) configured to selectively extend and retract the primary probe to contact the primary test location on the rear facet of the timepiece; and a secondary actuator (e.g., a linear actuator) configured to selectively extend and retract the secondary probe to contact the secondary test location on the rear facet of the timepiece.

Therefore, rather than the timepiece maintenance station sampling vibration signals generated by the movement at a single test location of the timepiece, which can result in inconsistent sampling of vibration signals, the timepiece maintenance station can: include a platform that accurately and repeatably locates test locations on a rear facet of the timepiece in alignment with probes embedded within the platform; and sample multiple vibration signals generated by the movement in the timepiece.

In other variations, the timepiece maintenance station can include any quantity (e.g., n-number of) of probes, such as embedded into the platform, configured to contact with the rear facet of the timepiece.

### 4.? Lateral Probes

In one implementation, the timepiece maintenance station includes a set of probes configured to contact a side facet of the timepiece, such as configured to contact a periphery of a bezel of the timepiece. In one example, the timepiece maintenance station includes: a platform including a primary set of probes embedded within the platform and configured to contact the rear facet of the timepiece; and a secondary set of probes, such as extending within an interior of the receptacle, configured to contact a periphery (e.g., a bezel) of the timepiece.

Therefore, the timepiece maintenance station can capture vibration signals generated by the movement across multiple target locations of the timepiece arranged within the timepiece maintenance station.

### 5. Heartbeat Profile

Blocks of the method S100 recite, defining a first heartbeat profile for uniquely identifying the first unverified timepiece as a first verified timepiece, the first heartbeat profile representing the first timeseries of periodic characteristics as a function of power reserve in the first movement in Block S140.

Generally, the system can execute Blocks of the method S100 to generate a heartbeat profile representing vibrations of the timepiece as a function of time (e.g., peak-to-peak intensities as a function of time). In particular, the system can execute Blocks of the method S100 to: during a target time period, record a timeseries of vibration signals from a vibration sensor coupled (e.g., via the probe) to the timepiece; detect a set of components (e.g., escapement, mainspring, balance wheel) of the movement in the timepiece and/or complications (e.g., minute hand, hour hand, date complication, month complication) coupled to the movement corresponding to a timeseries of periodic characteristics (e.g., amplitudes and/or frequencies) in the timeseries of vibration signals; and store the timeseries of vibration signals and the timeseries of periodic characteristics as a function of power reserve as the heartbeat profile uniquely representative of the timepiece.

### 5.1 Initial Data Capture

Blocks of the method S100 recite, during the first timepiece registration period at a first vibration sensor coupled to the first probe, capturing a first set of vibration signals characterizing power reserve depletion in a first movement of the first unverified timepiece in Block S120.

In one implementation, during an initial data capture cycle, the system can record a timeseries of vibration signals between: a first time corresponding to a high power reserve (e.g., between 95% and 100% power reserve) of the movement; and a second time—following the first time—corresponding to a low power reserve (e.g., between 5% and 10% power reserve of the movement. In this implementation, during an initial time period (e.g., 10 minutes, 30 minutes) prior to the initial data capture cycle, the system can: receive the timepiece at the platform, such as from a user interfacing with the system; and initiate a winding cycle by triggering the winding mechanism to rotate (e.g., clockwise, counter-clockwise) the platform—and therefore the movement—to increase the power reserve of the movement (i.e., by winding the mainspring of the movement).

Following the winding cycle, the system can then: trigger the probe—coupled to the vibration sensor—to contact a target location (e.g., rear facet, periphery) of the timepiece arranged on the platform; at a first time, corresponding to a high power reserve of the movement, initiate the data capture cycle to record a timeseries of vibration signals from the vibration sensor; and, at a second time, following the first time (e.g., 10 hours, 40 hours, 80 hours durations of time following the first time), corresponding to a low power reserve of the movement, terminate the initial data capture cycle. For example, at the second time, the system can: detect absence of vibrations from the vibration sensor coupled to the timepiece; and, in response to detecting the absence of vibrations, terminate the initial data capture cycle.

Furthermore, the system can: link the timeseries of vibration signals to an identifier (e.g., serial number) for the timepiece arranged within the timepiece maintenance station; store the timeseries of vibration signals as the heartbeat profile corresponding to the timepiece; and store the heartbeat profile—linked to the identifier of the timepiece—within a database (e.g., server) of the system. In one example, following the initial data capture cycle, the system can: initialize a tag; populate the tag with a serial number (e.g., Serial No. ABCD) of the timepiece arranged at the timepiece maintenance station, the start time of the initial data capture cycle, the end time of the initial data capture cycle, and a location of the timepiece maintenance station during the initial data capture cycle; link the tag to the heartbeat profile of the timepiece; and store the heartbeat profile within the database (e.g., server) of the system.

Therefore, the system can: record timeseries of vibration signals representing vibrations (e.g., peak-to-peak intensities) of a timepiece during a target time period corresponding to transition from a high power reserve to a low power reserve of the movement in the timepiece; and generate a heartbeat profile representing the timeseries of vibration signals as a function of power reserve of the movement uniquely representative of the timepiece, such as at a heartbeat database at the computer system.

### 5.2 Sampling

In one implementation, during the initial data capture cycle, the system can continuously record the timeseries of vibration signals from the vibration sensor—coupled to the timepiece—during the target time period corresponding to transition from the high power reserve to the low power reserve. Alternatively, the system can discretely record the timeseries of vibration signals at target time intervals (e.g., ten-minute intervals every hour, one hour every five hours) from the vibration sensor—coupled to the timepiece—during the target time period corresponding to transition from the high power reserve to the low power reserve. The system can then: aggregate the discretely recorded vibration signals into the timeseries of vibration signals; and store the timeseries of vibration signals as the heartbeat profile representing the timepiece.

### 5.2.1 Signal Processing: Multi-probe Signal Compilation

In the variation described above in which the system includes multiple (e.g., three) probes—such as embedded within the platform and/or arranged within the receptacle—in contact with the timepiece, the system can, during a sampling period (or “interval”): retrieve sets of vibration signals captured across multiple test locations—such as at the rear facet, front facet, periphery—on the timepiece during a sampling period; and combine these sets of vibration signals into a composite vibration signal representing vibrations generated by the movement in the timepiece during the sampling period.

In one implementation, the system can: implement signal preprocessing techniques (e.g., amplification, digitization) across the set of vibration signals in preparation for generating a composite vibration signal; implement filtering techniques (e.g., band-pass filters) to isolate vibration components in the movement of the timepiece represented in the set of vibration signals; implement signal combinatory techniques (e.g., signal averaging, frequency domain fusion, interpolation) to fuse the set of vibration signals into a composite vibration signal; and implement signal post-processing techniques (e.g., smoothing, filtering) to remove (or “filter out”) residual noise in the composite vibration signal.

In one example, during a sampling period, the system can: at a set of vibration sensors coupled to a set of probes embedded within a platform and in contact across a set of test locations on a rear facet of the timepiece, capture a set of vibration signals representing vibrations generated by the movement in the timepiece; apply a band-pass filter—characterized by a band-pass frequency range (e.g., 100 Hz to 96K Hz) and time domain features (e.g., beat-rate between two Hertz and five Hertz)—to isolate vibrations from components (e.g., mainspring, balance wheel, escapement) in the movement represented in the set of vibration signals; and implement signal combinatory techniques (e.g., signal averaging, frequency domain fusion, interpolation), as described above, to combine this set of filtered vibration signals into a composite vibration signal representing vibrations generated by the movement in the timepiece.

Therefore, rather than individually extracting periodic characteristics—as described below—from vibration signals captured across multiple test locations on the timepiece, the system can extract periodic characteristics from a composite vibration signal representing vibrations generated by the movement of the timepiece.

### 5.3 First Order Periodic Characteristics: Movement

Blocks of the method S100 recite during the first timepiece registration period, extracting a first timeseries of periodic characteristics from the first set of vibration signals in Block S130.

In one implementation, following the initial data capture cycle, the system can: implement signal processing techniques (e.g., filtering, Fourier transform techniques) to isolate a timeseries of first order periodic characteristics (e.g., frequencies, amplitudes) in the timeseries of vibration signals; and correlate the timeseries of first order periodic characteristics to components (e.g., escapement, mainspring, balance wheel) of the movement. More specifically, the system can leverage a known mechanical movement frequency band (e.g., between four hertz and six hertz) for a movement in a timepiece to isolate first order periodic characteristics (e.g., frequencies, amplitudes)—by applying a band-pass filter according to the mechanical movement frequency band—from the timeseries of vibration signals.

For example, following the initial data capture cycle, the system can: access a target frequency band (e.g., between four hertz and six hertz) associated with the movement of the timepiece; and implement a band-pass filter according to the target frequency band to generate a filtered timeseries of vibration signals. In another example, the system can: generate a prompt requesting a user interfacing with the system to input a target frequency band corresponding to the movement of the timepiece associated with the recorded timeseries of vibration signals; serve the prompt to the user, such as to an interactive display integrated at the receptacle; and, in response to receiving a frequency band input from the user at the interactive display, apply a band pass filter based on the frequency band input to generate a filtered timeseries of vibration signals.

Additionally, the system can: implement signal processing techniques (e.g., Fourier transform techniques) to extract a timeseries of first order periodic characteristics (e.g., frequencies, amplitudes) across the filtered timeseries of vibration signals in the heartbeat profile; correlate the timeseries of first order periodic characteristics to a suite of components (e.g., escapement, mainspring, balance wheel) of the movement inducing vibrations across the timepiece; and store the timeseries of periodic characteristics and the timeseries of vibration signals as the heartbeat profile uniquely representing the timepiece at the timepiece maintenance station. For example, the system can access a Fourier transform model specifying a suite of frequencies corresponding to components (e.g., escapement, mainspring, balance wheel) of the movement, and implement the Fourier transform model across the filtered timeseries of vibration signals to: extract an escapement periodic characteristic representing vibration signals (e.g., peak-to-peak intensities) from oscillations of the escapement of the movement in the heartbeat profile; extract a mainspring periodic characteristic representing vibration signals (e.g., peak-to-peak intensities) from oscillations of the mainspring of the movement in the heartbeat profile; and extract a balance wheel periodic characteristic representing vibration signals (e.g., peak-to-peak intensities) from oscillations of the balance wheel of the movement in the heartbeat profile.

For each heartbeat (i.e., for each periodic cycle) in the heartbeat profile, the system can: label a first peak amplitude corresponding to the escapement periodic characteristic; label a second peak amplitude corresponding to the balance wheel periodic characteristic; identify a first wave length between the first peak and the second peak in the heartbeat; and identify a second wave length between the second peak and a subsequent heartbeat in the heartbeat profile. Furthermore, the system can label amplitudes corresponding to the mainspring periodic characteristic for each heartbeat (i.e., for each periodic cycle) in the heartbeat profile.

Therefore, the system can: aggregate the escapement periodic characteristic, the mainspring periodic characteristic, and the balance wheel periodic characteristic across the timeseries of vibration signals into a timeseries of periodic characteristics; and store the timeseries of vibration signals and the timeseries of periodic characteristics into the heartbeat profile uniquely representing the timepiece arranged at the timepiece maintenance station.

### 5.4 Second Order Periodic Characteristics: Complications

In one implementation, following the initial data capture cycle, the system can: implement signal processing techniques (e.g., filtering, Fourier transform techniques) to isolate a timeseries of second order periodic characteristics (e.g., frequencies, amplitudes) in the timeseries of vibration signals; and correlate the timeseries of second order periodic characteristics to complications (e.g., minute hand, hour hand, date complication) coupled to the movement of the timepiece. More specifically, the system can leverage a known mechanical movement frequency band (e.g., between four hertz and six hertz) for a movement of a timepiece to isolate second order periodic characteristics (e.g., frequencies, amplitudes)—by applying a band-stop filter according to the mechanical movement frequency band—from the timeseries of vibration signals. Thus, by filtering out the known mechanical movement frequency band from the timeseries of vibration signals, the filtered timeseries of vibration signals represent vibration signals (e.g., peak-to-peak intensities) corresponding to motion of the complications of the timepiece.

Additionally, the system can: leverage known periodicities for complications (e.g., 60 ticks per hour for the minute complication, 24 ticks per hour for the hour complication) by implementing signal processing techniques (e.g., Fourier transform techniques) to extract the timeseries of second order timeseries of periodic characteristics across the filtered timeseries of vibration signals in the heartbeat profile; and correlate the timeseries of second order periodic characteristics to complications inducing vibrations across the timepiece. For example, the system can implement Fourier transform techniques to isolate vibration signals (e.g., peak-to-peak intensities) corresponding to: motion of the minute complication in the filtered timeseries of vibration signals according to a known periodicity of the minute complication (i.e., 60 ticks per hour); motion of the hour complication in the filtered timeseries vibration signals according to a known periodicity of the hour complication (i.e., 24 ticks per hour); motion of a date complication in the filtered timeseries of vibration signals according to a known periodicity of the date complication (i.e., 1 tick per day); and/or motion of a month complication in the filtered timeseries of vibration signals according to a known periodicity of the month complication (i.e., 1 tick per month).

Therefore, the system can: aggregate the extracted vibration signals (e.g., peak-to-peak intensities) from the complications of the timepiece into the timeseries of second order periodic characteristics; and store the timeseries of vibration signals, the timeseries of first order periodic characteristics, and the timeseries of second order periodic characteristics into the heartbeat profile for the timepiece.

In another implementation, the system can: access a timeseries of images from the optical sensor defining a field of view of the complications across the front facet of the timepiece; implement computer vision techniques to track motion of complications across the timeseries of images; and interpret a periodicity for a complication (e.g., hour complication, minute complication) based on tracked motion of the complications across the timeseries of images. In this implementation, the system can: implement Fourier transform techniques according to the periodicity for the complication (e.g., hour complication, minute complication) extracted from the timeseries of images to isolate peak-to-peak intensities corresponding to the complication from the filtered timeseries vibration signals; and aggregate isolated peak-to-peak intensities for a suite of complications into the timeseries of second order periodic characteristics.

Therefore, the system can generate a heartbeat profile uniquely representing a timepiece and characterized by: a timeseries of first order periodic characteristics corresponding to components (e.g., escapement, mainspring, balance wheel) of the movement in the timepiece; and a timeseries of second order periodic characteristics corresponding to complications (e.g., hour complication, minute complication) of the timepiece.

### 5.5 Power Reserve Map

In one implementation, the system can: generate a set of time windows (e.g., sequence of 2-hour time windows) across the heartbeat profile, each time window corresponding to a power reserve level (e.g., 50%, 80%) of the movement; link periodic characteristics (e.g., first order, second order) from the heartbeat profile during the time window to the power reserve level; and generate a power reserve map by linking periodic characteristics of vibration signals to the set of time windows corresponding to power reserve levels of the movement. For example, the system can: as described above, extract a mainspring periodic characteristic from the heartbeat profile during the time window corresponding to a fifty-percent power level of the movement; identify a peak amplitude and a wavelength in the mainspring periodic characteristics; and, in a power reserve map, link the peak amplitude and the wavelength of the mainspring periodic characteristic to the time window corresponding to the fifty-percent power level of the movement.

Accordingly, the system can repeat this process across the set of time windows of the heartbeat profile to generate a power reserve map representing power levels from a maximum power (e.g., 100%) reserve to a minimum power reserve (e.g., 5%) of the movement. Therefore, the system can, following a data capture cycle, track a power reserve of the movement at the timepiece maintenance station based on the heartbeat profile in order to verify an operating condition for the movement in the timepiece.

### 5.6 Interpolation

In one implementation, the system can implement interpolation techniques to transform the discrete timeseries of periodic characteristics extracted from the set of vibration signals into a continuous timeseries of periodic characteristics across a full range of power reserves in the movement of the timepiece. In this implementation, the system can: segment the timeseries of periodic characteristics into a discrete set of power reserve ranges (e.g., incremental ranges of 5%); interpolate periodic characteristics across the discrete set of power reserve ranges to generate a continuous sequence of periodic characteristics representing continuous transition from a high-power reserve to a low-power reserve in the first movement; and define the heartbeat profile as the continuous sequence of periodic characteristics across a full range of power reserve in the movement.

In one example, the system can: aggregate a discrete set of periodic characteristics into a power reserve range (e.g. five-percent); and implement interpolation techniques to transform the discrete set of periodic characteristics within the power reserve range into a continuous sequence of periodic characteristics across the five-percent power reserve range. In this example, the system can then: repeat this process across all segments of the power reserve range specified in the heartbeat profile (e.g., a ten-percent power reserve range, a fifteen-percent power reserve range); and thus, generate a continuous sequence of periodic characteristics as a function of full power reserve in the movement of the timepiece.

Therefore, the system can define a heartbeat profile to uniquely define a timepiece, which is represented by a continuous sequence of periodic characteristics as a function of the full power reserve in the movement of the timepiece.

### 5.7 Spatial and Temporal Profile

As described above, the timepiece maintenance station can concurrently sample multiple (e.g., more than one) vibration signals generated by the movement of the timepiece during a sampling period at the timepiece maintenance station. In one implementation, the system can then implement temporal integration techniques and spatial integration techniques to transform these multiple vibration signals into a three-dimensional temporal profile uniquely representing the timepiece. In this implementation, the system can: capture a set of vibration signals across multiple test locations on a timepiece during power reserve depletion in a movement of the timepiece; implement temporal integration techniques to temporally synchronize these set of vibration signals, such as according to time stamps recorded during capture of the set of vibration signals; and implement spatial integration techniques spatially align these vibration signals to spatial coordinates within a three-dimensional model of the timepiece based on the test locations on the timepiece. Accordingly, the system can then store this temporal three-dimensional model as the heartbeat profile to uniquely identify the timepiece.

In one example, the system can: overlay a spatial grid about the three-dimensional model of the timepiece; implement spatial interpolation techniques to estimate periodic characteristics across spatial regions between these spatial coordinates; and populate cells in the spatial grid with the interpolated periodic characteristics. Additionally, the system can implement temporal and spatial visualization techniques (e.g., heatmaps, contour plots) to: depict these temporal and spatial variations of the interpolated periodic characteristics across the spatial grid; and track changes in the interpolated periodic characteristics as a function of power reserve across the spatial grid.

Therefore, the system can define a three-dimensional temporal heartbeat profile that: spatially and temporally tracks periodic characteristics across a movement of the timepiece as a function power reserve in the movement of the timepiece; and represents unique alignment and/or balance of specific components (e.g., the balance wheel, the escapement, the mainspring) of the movement in the timepiece.

### 5.8 Profile Library

In one implementation, the system can: receive a unique identifier (e.g., a serial number, a registered logo, a custom engraving, a color) associated with a timepiece; link a heartbeat profile defined for a timepiece to this unique identifier; and aggregate the heartbeat profile into a library of heartbeat profiles, such as stored at a remote computer system, associated with a suite of timepieces for a registered user of the timepiece maintenance station.

For example, during a timepiece registration period, the system can: generate a prompt requesting an operator to input a serial No. (e.g., R123456) associated with a timepiece currently loaded onto the timepiece maintenance station; serve this prompt to an interactive display at the timepiece maintenance station and/or to an external device (e.g., tablet) associated with a user; and receive input of the serial No. (e.g., R123456) for the timepiece arranged within the timepiece maintenance station. Additionally or alternatively, the system can extract the serial No. (e.g., R123456) from an inspection image captured at the timepiece maintenance station. After defining the heartbeat profile for uniquely identifying the timepiece, as described above, the system can: link the serial No. (e.g., R123456) of the timepiece to the heartbeat profile; and aggregate the heartbeat profile in a library of heartbeat profiles (e.g., local and/or remote database of heartbeat profiles). In this example, the system can then repeat this process for a suite of timepieces, such as a suite of timepieces associated with a registered user for the timepiece maintenance station.

In another implementation, the system can: access a timepiece specification (e.g., a digital document) specifying unique identifiers for the timepiece and/or a maintenance history of the timepiece; and extract these unique identifiers from the timepiece specification.

Therefore, the system can maintain a database of heartbeat profiles for uniquely identifying a suite of timepieces associated with a user of the timepiece maintenance station.

### 6. Watch Identification

Blocks of the method S100 recite, during a first timepiece identification period following the first timepiece registration period: at the timepiece maintenance station, triggering the first probe to contact a second unverified timepiece arranged within the timepiece maintenance station in Block S150; and, at the first vibration sensor coupled to the first probe, capturing a second vibration signal representing vibrations generated by a second movement of the second unverified timepiece in Block S160.

Blocks of the method S100 further recite, during the first timepiece identification period following the first timepiece registration period: extracting a second timeseries of periodic characteristics from the second vibration signal in Block S170; and, in response to the second timeseries of periodic characteristics approximating periodic characteristics represented in a first power reserve range within the first heartbeat profile, identifying the second unverified timepiece as the first verified timepiece in Block S180.

Generally, the system can identify recorded timeseries of vibration signals—from a timepiece at the timepiece maintenance station—as corresponding to a heartbeat profile associated with an identifier (e.g., serial number) for a particular timepiece stored at the computer system. In particular, the system can: following the initial data capture cycle (e.g., following wearing of the timepiece by the user), receive the timepiece on the platform within the timepiece maintenance station; as described above, initiate a data capture cycle to record a timeseries of vibration signals corresponding to vibrations from the timepiece over a target time period (e.g., thirty seconds, sixty seconds); and identify the timeseries of vibration signals as corresponding to a particular heartbeat profile for the timepiece.

In one implementation, the system can: as described above, implement signal processing techniques (e.g., filtering, Fourier transform techniques) to extract a timeseries of first order periodic characteristics from the timeseries of vibration signals; and identify the timepiece as corresponding to a heartbeat profile by approximating the timeseries of first order periodic characteristics to target first order periodic characteristics specified in the heartbeat profile. In one example, the system can: as described above, identify a first peak amplitude corresponding to a balance wheel periodic characteristic in the timeseries of vibration signals; identify a second peak amplitude corresponding to an escapement periodic characteristic in the timeseries of vibration signals; and interpret a first wavelength between the first peak amplitude and the second peak amplitude in the timeseries of vibration signals. In this example, the system can then: from the heartbeat profile, extract a target wavelength between a peak amplitude corresponding to a balance wheel periodic characteristic and a peak amplitude corresponding to an escapement periodic characteristic; and, in response to the first wavelength approximating the target wavelength (e.g., within a target threshold), identify the timepiece as corresponding to the heartbeat profile.

Similarly, the system can: as described above, implement signal processing techniques (e.g., filtering, Fourier transform techniques) to extract a timeseries of second order periodic characteristics from the timeseries of vibration signals; and identify the timepiece as corresponding to a heartbeat profile in response to approximating the timeseries of second order periodic characteristics to target second order periodic characteristics specified in the heartbeat profile of the timepiece. For example, the system can: as described above, identify vibration signals (e.g., peak-to-peak intensities) corresponding to motion of the minute complication of the movement in the timeseries of vibration signals; from the heartbeat profile, extract target vibration signals (e.g., peak-to-peak intensities) corresponding to motion of the minute complication of the movement from the heartbeat profile; and, in response to the vibration signals from the timeseries of vibration signals approximating the target vibration signals (e.g., within a target threshold), identify the timepiece as corresponding to the heartbeat profile.

In one implementation, the system can: identify absence of a heartbeat profile as corresponding to the timeseries of vibration signals; and, in response to identifying the absence, trigger the timepiece maintenance station to initiate an initial data capture cycle in order to generate a heartbeat profile representing the touch image at the timepiece maintenance station. In this implementation, the system can: as described above, record a timeseries of vibration signals during transition of the movement of the timepiece from a high power reserve to a low power reserve; extract a timeseries of first order periodic characteristics and a timeseries of second order periodic characteristics from the timeseries of vibration signals; and store the timeseries of vibration signals, the timeseries of first order periodic characteristics, and the timeseries of second order periodic characteristics as a first heartbeat profile for the timepiece at the timepiece maintenance station. The system can then: query a database containing a set of heartbeat profiles—corresponding to timepieces associated with a user profile—for a particular heartbeat profile approximating the first heartbeat profile (e.g., within a target threshold); and, in response to approximating periodic characteristics in the first heartbeat profile to periodic characteristics in the particular heartbeat profile retrieved from the database, identify the timepiece at the timepiece maintenance station as a verified timepiece specified for the particular heartbeat profile.

Alternatively, in response to absence of the first heartbeat profile approximating a heartbeat profile in the database, the system can: generate a notification specifying that a new timepiece is detected at the timepiece maintenance station; and display the notification, such as at an interactive display at the timepiece maintenance station. Additionally, the system can: generate a prompt requesting a user, interfacing with the system, to confirm selection of a new timepiece and/or to schedule maintenance for the timepiece and/or to update a current heartbeat profile for a particular timepiece in the user profile; and serve the prompt to the user.

Therefore, the system can: record a timeseries of vibration signals from a vibration sensor—coupled to a timepiece at the timepiece maintenance station—during a data capture cycle; and uniquely identify the timepiece, such as identifying a serial number of the timepiece, by approximating the timeseries of vibration signals to a heartbeat profile corresponding to the serial number of the timepiece.

### 6.1 Power Reserve Detection

Blocks of the method S100 recite: estimating a first power reserve level of the first verified timepiece based on the first power reserve range within the first heartbeat profile in Block S190; defining a winding cycle to maintain the first verified timepiece at a target power reserve level at the timepiece maintenance station in Block S192; and, at the timepiece maintenance station, initiating the winding cycle to increase the first power reserve level of the first verified timepiece toward the target power reserve level in Block S194. Generally, the system can execute Blocks of the method S100 to maintain a timepiece at a target power level reserve within the timepiece maintenance station.

In one implementation, the system can: record a timeseries of vibration signals for a timepiece at the timepiece maintenance station; access a heartbeat profile corresponding to the timepiece (e.g., corresponding serial number); and identify a power reserve of the movement of the timepiece based on the heartbeat profile and the timeseries of vibration signals. In particular, the system can: as described above, extract a timeseries of periodic characteristics (e.g., first order, second order) from the timeseries of vibration signals; identify a time window (e.g., 30 minutes, 1 hour) in the heartbeat profile containing the timeseries of periodic characteristics from the timeseries of vibration signals; and identify the power reserve of the movement of the timepiece corresponding to the time window containing the timeseries of periodic characteristics in the heartbeat profile.

For example, the system can: as described above, extract a mainspring periodic characteristic from the timeseries of vibration signals representing oscillations across the timepiece generated from the mainspring of the movement; identify a peak intensity of the mainspring periodic characteristic from the timeseries of vibration signals; identify a time window—corresponding to a power reserve level—in the heartbeat profile containing the peak intensity of the mainspring periodic characteristic; and identify the power reserve of the movement as the power reserve level corresponding to the time window across the heartbeat profile. Therefore, the system can track power reserve levels of the movement in the timepiece at the timepiece maintenance station in order to prevent a non-operating condition of the timepiece, as described below.

### 6.3 Retrieving Heartbeat Profile

In one implementation, during a timepiece identification period, the system can: generate a prompt requesting a user to input an identifier (e.g., serial number, timepiece classification) for an unverified timepiece arranged within the timepiece maintenance station; serve the prompt to a registered user associated with the timepiece maintenance station; and receive an input specificizing the unique identifier for the timepiece. In this implementation, the system can then: access a library of heartbeat profiles associated with a population of verified timepieces; and retrieve a particular heartbeat profile, from the library of heartbeat profiles, linked to the unique identifier. For example, the system can: receive an input specifying a serial number for an unverified timepiece arranged within the timepiece maintenance station; and retrieve a heartbeat profile—linked to the serial number—from the library of heartbeat profiles.

In another implementation, the system can: access an inspection image depicting the timepiece arranged within the timepiece maintenance station; detect presence of a unique identifier for the timepiece in the inspection image; and retrieve a particular heartbeat profile, from the library of heartbeat profiles, linked to the unique identifier. For example, the system can: implement computer vision techniques, as described above, to detect presence of a serial number arranged on (e.g., printed, engraved) on the timepiece; and retrieve a heartbeat profile—linked to the serial number—from the library of heartbeat profiles.

In another implementation, the system can: access an inspection image depicting the timepiece arranged within the timepiece maintenance station; implement computer vision techniques, as described above, to identify a timepiece classification (e.g., brand, model, series) of the unverified timepiece; and retrieve a set of heartbeat profiles, from the library of heartbeat profiles, associated with this timepiece classification.

Therefore, the system can autonomously and/or manually retrieve a heartbeat profile predicted to uniquely identify an unverified timepiece arranged within the timepiece maintenance station.

### 6.2 Characteristics Mapping

In one implementation, the system can: map a set of periodic characteristics extracted from a vibration signal of the timepiece recorded during a timepiece identification period; characterize a difference between periodic characteristics represented in a heartbeat profile and periodic characteristics extracted from the vibration signal recorded during the timepiece identification period; and, in response to the difference falling below a threshold different (e.g., falling below a difference of 0.001 meters per second squared, 0.01 millivolts), identifying the timepiece as a verified timepiece. In this implementation, the system can implement artificial intelligence techniques (e.g., convolutional neural networks, gradient-boosted trees) to identify a power reserve range in a heartbeat profile, retrieved from a library of heartbeat profiles, approximating the timeseries of periodic characteristics extracted from the vibration signal recorded during the timepiece identification period.

In one example, the system can: isolate a periodic cycle in the vibration signal recorded during the timepiece identification period; and detect a set of peak-to-peak amplitudes, such as for a balance wheel, an escapement, and/or a mainspring in a movement of the timepiece, in the periodic cycle. The system can then: map the set of peak-to-peak amplitudes detected in the periodic cycle to a power reserve range of the first heartbeat profile; and characterize a difference between peak-to-peak amplitudes represented in the power reserve range of the first heartbeat profile and the set of peak-to-peak amplitudes detected in the periodic cycle. Thus, in response to the difference falling below a threshold difference, the system can: match the first set of peak-to-peak amplitudes to the first power reserve range; and uniquely identify the unverified timepiece as a first verified timepiece.

Therefore, the system can identify an unverified timepiece arranged within the timepiece maintenance station as a verified timepiece associated with a previously generated and/or confirmed heartbeat profile.

### 6.4 Updating Heartbeat Profile: False Positives

In one implementation, the system can: based on a unique identifier of a timepiece arranged within the timepiece maintenance station, retrieve a heartbeat profile associated with the unique identifier from a library of heartbeat profiles; detect absence of a match between periodic characteristics extracted from a vibration signal recorded during the timepiece identification period and periodic characteristics represented in the heartbeat profile; and, in response to detecting this absence, identifying a false-positive identification of the timepiece. The system can then: generate a prompt for a user to initiate a new timepiece registration period for the timepiece define a new heartbeat profile; serve the prompt to the user; and, in response to receiving confirmation from the user, replace the heartbeat profile linked to the unique identifier with the new heartbeat profile.

For example, the system can: retrieve a heartbeat profile specified for a serial number of the timepiece arranged within the timepiece maintenance station; detect absence of a match between peak-to-peak intensities recorded for the timepiece and peak-to-peak intensities represented in the heartbeat profile; and, in response to detecting absence of this match initiating a timepiece registration period to define a new heartbeat profile for the timepiece.

In another example, upon servicing a movement, the heartbeat is recorded to allow the system to take into account acoustic changes caused by changes in characteristics of the movement due to service, or serviceable part replacement.

Therefore, the system can periodically update an existing heartbeat profile with a new heartbeat profile to maintain a library of heartbeat profiles for uniquely identifying a suite of timepieces associated with a registered user.

### 6.5 Timepiece Classification

In one implementation, the system can implement the steps described above to generate a heartbeat profile uniquely representative of a timepiece classification (or “type”)—such as specifying a brand, model, series, style, and/or function of a timepiece—associated with a population of timepieces. In this implementation, the system can: assign a timepiece classification (e.g., chronograph timepiece, diving timepiece, dress timepiece, perpetual calendar timepiece, Greenwich mean time timepiece) to a previously defined heartbeat profile; and, in response to periodic characteristics of an unverified timepiece approximating periodic characteristics represented in the heartbeat profile, identify the unverified timepiece as belonging to the timepiece classification specified for the heartbeat profile. Accordingly, the system can group heartbeat profiles—such as stored in the heartbeat profile library—according to this timepiece classification.

Therefore, the system can identify timepieces as belonging to a timepiece classification specified for a population of timepieces associated with a registered user.

### 7. Movement Maintenance

In one implementation, the system can: as described above, initiate a data capture cycle to record a timeseries of vibration signals corresponding to vibrations of the movement over a target time period (e.g., thirty seconds); identify the timeseries of vibration signals as corresponding to a particular heartbeat profile for a timepiece; and, as described above, interpret a power reserve for the movement in the timepiece at the timepiece maintenance station based on the timeseries of vibration signals and the heartbeat profile. In this implementation, the system can: extract a timeseries of first order periodic characteristics from the timeseries of vibration signals; identify a time window in the heartbeat profile containing the timeseries of first order periodic characteristics; and interpret a power reserve of the movement according to a location of the time window in the heartbeat profile. For example, the system can: identify a time window relative a middle location in the heartbeat profile; and interpret a fifty-percent power reserve for the movement according to the time window in the heartbeat profile.

In one implementation, the system can: generate a prompt requesting a user, interfacing with the system, to specify a target power reserve for the movement;

serve the prompt to the user, such as at an interactive display at the timepiece maintenance station and/or a mobile device associated with the user; and receive the target power reserve from the user. The system can then, in response to the power reserve of the movement falling below the target power reserve, initiate a winding cycle to increase the power reserve of the movement toward the target power reserve by triggering a winding mechanism at the timepiece maintenance station to rotate (e.g., clockwise, counterclockwise) the platform supporting the timepiece.

Alternatively, in response to the power reserve of the movement exceeding the target power reserve, the system can: based on the heartbeat profile, predict a time period corresponding to transition from a current power reserve of the movement to a power reserve falling below the target power reserve; following the time period, initiate a data capture cycle to capture a timeseries of vibration signals; based on the timeseries of vibration signals and the heartbeat profile, interpret a second power reserve for the movement; and, in response to the second power reserve falling below the target power reserve, initiate a winding cycle to increase power reserve of the movement toward the target power reserve by triggering a winding mechanism at the timepiece maintenance station to rotate (e.g., clockwise, counterclockwise) the platform supporting the timepiece.

Therefore, the system can maintain a target power reserve (e.g., 85%) for the movement by routinely (e.g., every 5 hours, every day): interpreting a power reserve for a movement in the timepiece at the timepiece maintenance station; and, in response to the power reserve falling below the target power reserve, initiate a winding cycle to increase power reserve of the movement toward the target power reserve by triggering a winding mechanism at the timepiece maintenance station to rotate (e.g., clockwise, counterclockwise) the platform supporting the timepiece.

### 8. Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer-readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during a first timepiece registration period:
at a timepiece maintenance station, triggering a first probe to contact a first unverified timepiece arranged within the timepiece maintenance station;
at a first vibration sensor coupled to the first probe, capturing a first set of vibration signals characterizing power reserve depletion in a first movement of the first unverified timepiece;
extracting a first timeseries of periodic characteristics from the first set of vibration signals;
defining a first heartbeat profile for uniquely identifying the first unverified timepiece as a first verified timepiece, the first heartbeat profile representing the first timeseries of periodic characteristics as a function of power reserve in the first movement; and
during a first timepiece identification period following the first timepiece registration period:
at the timepiece maintenance station, triggering the first probe to contact a second unverified timepiece arranged within the timepiece maintenance station;
at the first vibration sensor coupled to the first probe, capturing a second vibration signal representing vibrations generated by a second movement of the second unverified timepiece;
extracting a second timeseries of periodic characteristics from the second vibration signal; and
in response to the second timeseries of periodic characteristics approximating periodic characteristics represented in a first power reserve range within the first heartbeat profile, identifying the second unverified timepiece as the first verified timepiece.

2. The method of claim 1:
further comprising, preceding the first timepiece registration period, initiating a winding cycle to increase a first power reserve level in the first movement toward a high-power reserve level;
herein capturing the first set of vibration signals characterizing power reserve depletion in the first movement of the first unverified timepiece comprises:
discretely sampling vibrations generated by the first movement during transition of the first movement from the high-power reserve level to a low-power reserve level over a first duration of time; and
wherein capturing the second vibration signal representing vibrations generated by a second movement of the second unverified timepiece comprises:
continuously sampling vibrations generated by the second movement during operation of the second movement over a second duration of time less than the first duration of time.

3. The method of claim 1, further comprising:
estimating a first power reserve level of the first verified timepiece based on the first power reserve range within the first heartbeat profile;
defining a winding cycle to maintain the first verified timepiece at a target power reserve level at the timepiece maintenance station; and
at the timepiece maintenance station, initiating the winding cycle to increase the first power reserve level of the first verified timepiece toward the target power reserve level.

4. The method of claim 1, wherein extracting the first timeseries of periodic characteristics from the first set of vibration signals comprises:
applying a band-pass filter to the first set of vibration signals to isolate vibration components associated with a mainspring, a balance wheel, and an escapement in the first movement, the band-pass filter characterized by a band-pass frequency range between 2.5 Hertz and 5 Hertz;
detecting a first timeseries of peak-to-peak intensities, in the first set of vibration signals, of the vibration components within the band-pass frequency range; and
aggregating the first timeseries of peak-to-peak intensities, associated with the first movement, into first order periodic characteristics in the first timeseries of periodic characteristics.

5. The method of claim 4, wherein defining the first heartbeat profile for uniquely identifying the first unverified timepiece as the first verified timepiece comprises defining the first heartbeat profile representing first order periodic characteristics in the first timeseries of periodic characteristics as a function of power reserve in the first movement.

6. The system of claim 4:
further comprising during the first timepiece registration period:
at the timepiece maintenance station, capturing a first timeseries of inspection images depicting a first complication of the first unverified timepiece;
tracking motion of the first complication across the first timeseries of inspection images; and
interpreting a first periodicity of the first complication based on tracked motion of the first complication across the first timeseries inspection images;
wherein extracting the first timeseries of periodic characteristics from the first set of vibration signals further comprises:
isolating a second timeseries of peak-to-peak intensities, associated with the first complication, in the first set of vibration signals according to the first periodicity; and
aggregating the second timeseries of peak-to-peak intensities, associated with the first complication, into second-order periodic characteristics in the first timeseries of periodic characteristics; and
wherein defining the first heartbeat profile for uniquely identifying the first unverified timepiece as the first verified timepiece comprises defining the first heartbeat profile representing first order periodic characteristics and second order periodic characteristics in the first timeseries of periodic characteristics as a function of power reserve in the first movement.

7. The system of claim 1:
wherein extracting the second timeseries of periodic characteristics from the first vibration signal comprises:
applying a first filter to the second vibration signal to isolate vibration components associated with a mainspring, a balance wheel, and an escapement in the second movement, the first filter characterized by a band-pass frequency range;
detecting a first timeseries of peak-to-peak intensities, in the second vibration signal, of the vibration components within the band-pass frequency range;
aggregating the first timeseries of peak-to-peak intensities into first order periodic characteristics in the second timeseries of periodic characteristics;
applying a second filter to the second vibration signal to isolate vibration components associated with a complication in the second movement, the second filter characterized by a low-pass frequency range less than the band-pass frequency range;
detecting a second timeseries of peak-to-peak intensities, in the second vibration signal, of the vibration components within the low-pass frequency range; and
aggregating the second timeseries of peak-to-peak intensities into second order periodic characteristics in the second timeseries of periodic characteristics; and
wherein identifying the second unverified timepiece as the first verified timepiece specified comprises:
in response to first order periodic characteristics and second order periodic characteristics in the second timeseries of periodic characteristics approximating first order periodic characteristics and second order periodic characteristics represented in the first power reserve range of the first heartbeat profile, identifying the first unverified timepiece as the first verified timepiece specified for the first heartbeat profile.

8. The system of claim 1, wherein defining the first heartbeat profile for uniquely identifying the first unverified timepiece as the first verified timepiece comprises:
segmenting the first timeseries of periodic characteristics into a discrete set of power reserve ranges;
interpolating periodic characteristics across the discrete set of power reserve ranges to generate a continuous sequence of periodic characteristics representing continuous transition from a high-power reserve to a low-power reserve in the first movement; and
defining the first heartbeat profile as the continuous sequence of periodic characteristics across a full range of power reserve in the first movement.

9. The method of claim 1:
wherein extracting the second timeseries of periodic characteristics from the second vibration signal comprises:
isolating a periodic cycle in the second vibration signal; and
detecting a set of peak-to-peak amplitudes in the periodic cycle; and
wherein identifying the second unverified timepiece as the first verified timepiece comprises:
mapping the set of peak-to-peak amplitudes detected in the periodic cycle to the first power reserve range of the first heartbeat profile;
characterizing a difference between peak-to-peak amplitudes represented in the first power reserve range of the first heartbeat profile and the set of peak-to-peak amplitudes detected in the periodic cycle; and
in response to the difference falling below a threshold difference:
matching the first set of peak-to-peak amplitudes to the first power reserve range; and
uniquely identifying the second unverified timepiece as the first verified timepiece.

10. The method of claim 1, further comprising:
during the first timepiece registration period:
at the timepiece maintenance station, capturing a first inspection image depicting a first case of the first unverified timepiece;
detecting presence of a first identifier for the first unverified timepiece in the first inspection image;
linking the first identifier to the first heartbeat profile for uniquely identifying the first unverified timepiece as the first verified timepiece; and
aggregating the first heartbeat profile, into a library of heartbeat profiles, associated with a population of verified timepieces;
during the first timepiece identification period:
accessing the library of heartbeat profiles;
at the timepiece maintenance station, capturing a second inspection image depicting a second case of the second unverified timepiece;
detecting presence of second identifier for the second unverified timepiece in the second inspection image;
in response to the second identifier matching the first identifier linked to the first heartbeat profile, retrieving the first heartbeat profile from the library of heartbeat profiles.

11. The method of claim 1, further comprising:
accessing a library of heartbeat profiles associated with a population of verified timepieces;
during a second timepiece identification cycle following the first timepiece registration period:
at the timepiece maintenance station, triggering the first probe to contact a third unverified timepiece arranged within the timepiece maintenance station;
at the first vibration sensor coupled to the first probe, capturing a third vibration signal representing vibrations generated by a third movement of the third unverified timepiece;
extracting a third timeseries of periodic characteristics from the third vibration signal; and
in response to absence of the third timeseries of periodic characteristics approximating periodic characteristics represented in a power reserve range of a heartbeat profile, in the library of heartbeat profiles, initiating the second timepiece registration cycle for the third unverified timepiece.

12. The method of claim 1:
wherein triggering the first probe to contact the first unverified timepiece arranged within the timepiece maintenance station comprises, at the timepiece maintenance station, triggering the first probe to contact a first target location on a rear facet of the first unverified timepiece;
further comprising:
at the timepiece maintenance station, triggering a second probe to contact a second target location on the rear facet of the first unverified timepiece;
at a second vibration sensor coupled to the second probe, capturing a third set of vibration signals characterizing power reserve depletion in the first movement of the first unverified timepiece; and
extracting a third timeseries of periodic characteristics from the third set of vibration signals; and
wherein defining the first heartbeat profile for uniquely identifying the first unverified timepiece as the first verified timepiece comprises defining the first heartbeat profile representing the first timeseries of periodic characteristics and the third timeseries of periodic characteristics as a function of power reserve in the first movement.

13. The method of claim 1:
wherein triggering the first probe to contact the first unverified timepiece arranged within the timepiece maintenance station comprises, at the timepiece maintenance station, triggering the first probe to contact a first target location on a rear facet of the first unverified timepiece;
further comprising:
at the timepiece maintenance station, triggering a second probe to contact a second target location on the rear facet of the first unverified timepiece;
at a second vibration sensor coupled to the second probe, capturing a third set of vibration signals characterizing power reserve depletion in the first movement of the first unverified timepiece; and
based on the first set of vibration signals and the third set of vibration signals, generating a composite vibration signal; and
wherein extracting the first timeseries of periodic characteristics from the first set of vibration signals comprises extracting the first timeseries of periodic characteristics from the composite vibration signals.

14. A method comprising, during a timepiece identification period:
accessing a library of heartbeat profiles, associated with a population of verified timepieces, defined prior to the timepiece identification period by:
for each timepiece in the population of verified timepieces:
accessing a set of vibration signals characterizing power reserve depletion in a movement of the timepiece;
extracting a timeseries of periodic characteristics from the set of vibration signals; and
defining a heartbeat profile, in the library of heartbeat profiles, representing the timeseries of periodic characteristics as a function of power reserve in the movement;
at a timepiece identification station, triggering a probe to contact a first unverified timepiece arranged within the timepiece maintenance station;
at a vibration sensor coupled to the probe, capturing a first vibration signal representing vibrations generated by a first movement of the first unverified timepiece;
extracting a first timeseries of periodic characteristics from the first vibration signal; and
in response to the first timeseries of periodic characteristics approximating periodic characteristics represented within a first heartbeat profile, in the library of heartbeat profiles, identifying the first unverified timepiece as a first verified timepiece specified for the first heartbeat profile.

15. The method of claim 14, wherein identifying the first unverified timepiece as a first verified timepiece specified for the first heartbeat profile comprises, in response to the first timeseries of periodic characteristics approximating periodic characteristics represented in a first power reserve range within the first heartbeat profile, in the library of heartbeat profiles, identifying the first unverified timepiece as the first verified timepiece specified for the first heartbeat profile.

16. The system of claim 14:
wherein extracting the first timeseries of periodic characteristics from the first vibration signal comprises:
applying a first filter to the first vibration signal to isolate vibration components associated with a mainspring, a balance wheel, and an escapement in the first movement, the first filter characterized by a band-pass frequency range;
detecting a first timeseries of peak-to-peak intensities, in the first vibration signal, of the vibration components within the band-pass frequency range;
aggregating the first timeseries of peak-to-peak intensities into first order periodic characteristics in the first timeseries of periodic characteristics;
applying a second filter to the first vibration signal to isolate vibration components associated with a complication in the first movement, the second filter characterized by a low-pass frequency range less than the band-pass frequency range;
detecting a second timeseries of peak-to-peak intensities, in the first vibration signal, of the vibration components within the low-pass frequency range; and
aggregating the second timeseries of peak-to-peak intensities into second order periodic characteristics in the first timeseries of periodic characteristics;
wherein identifying the first unverified timepiece as the first verified timepiece specified for the first heartbeat profile comprises:
in response to first order periodic characteristics and second order periodic characteristics in the first timeseries of periodic characteristics approximating first order periodic characteristics and second order periodic characteristics represented within the first heartbeat profile, in the library of heartbeat profiles, identifying the first unverified timepiece as the first verified timepiece specified for the first heartbeat profile.

17. The system of claim 14, wherein identifying the first unverified timepiece as the first verified timepiece specified for the first heartbeat profile comprises:
characterizing a difference between periodic characteristics represented in the first heartbeat profile and the first timeseries of periodic characteristics; and
in response to the difference falling below a threshold difference:
matching the first timeseries of periodic characteristics to a first power reserve range in the first heartbeat profile; and
uniquely identifying the first unverified timepiece as the first verified timepiece.

18. A method comprising, during a timepiece identification period:
accessing a first heartbeat profile, associated with a first timepiece classification, defined prior to the timepiece identification period by:
accessing a set of vibration signals characterizing power reserve depletion in a movement of the first timepiece classification;
extracting a timeseries of periodic characteristics from the set of vibration signals; and
defining the first heartbeat profile representing the timeseries of periodic characteristics as a function of power reserve in the movement of the first timepiece classification;
at a timepiece identification station, triggering a probe to contact a first unverified timepiece arranged within the timepiece maintenance station;
at a vibration sensor coupled to the probe, capturing a first vibration signal representing vibrations generated by a first movement of the first unverified timepiece;
extracting a first timeseries of periodic characteristics from the first vibration signal; and
in response to the first timeseries of periodic characteristics approximating periodic characteristics represented within a first heartbeat profile, identifying the first unverified timepiece as a first verified timepiece associated with the first timepiece classification.
